(19) United States
(12) Patent Application Publication
(10) Pub. No.: US 2006/0203985 A1
(43) Pub. Date: Sep. 14, 2006

(54) Call reroute to available ringback tone server

(76) Inventor: Kevin D. Beauford, Chicago, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/078,850

(22) Filed: Mar. 11, 2005

(51) Int. Cl. H04M 3/42

(52) U.S. Cl. 379/211.01

(57) ABSTRACT

A call is rerouted to an available ringback tone server to play a ringback tone to a calling communication device on the call after an attempt to route the call to an unavailable ringback tone server.

### CROSS-REFERENCE TO RELATED APPLICATIONS

This application contains subject matter that is related to the subject matter of the following applications, which are assigned to the same assignee as this application. The below-listed applications are hereby incorporated herein by reference in their entireties:

“FEEDBACK TO CALLING COMMUNICATION DEVICE ON CALL CONNECTED WITH INTELLIGENT NETWORK SIGNALING,” by Batni et al., Ser. No. 10/683,969, filed Oct. 10, 2003.

“CALL CATEGORY FOR A CALL THAT TERMINATES AT ANNOUNCEMENT SERVER COMPONENT,” by Kevin D. Beauford, Ser. No. 10/697,216, filed Oct. 30, 2003.

### TECHNICAL FIELD

The invention relates generally to communications and more particularly to called party selected ringback tones played to the calling party.

### BACKGROUND

Known ringback tone services allow a called party to preselect a ringback tone to be played to a calling party on a call to the called party. Traditionally, the calling party would hear a standard ringing sound while waiting for the called party to answer the call. The ringback tone service replaces that standard ringing sound with the ringback tone selected by the called party. For example, the ringback tone service allows the called party to customize the ringing sound that a calling party hears while calling the called party.

The ringback tone service employs a ringback tone server in a telecommunications network to play ringback tones to calling parties. Switching centers in the telecommunications network establish connections with the ringback tone server for calls that require ringback tones. An attempted connection to the ringback tone server may be unsuccessful. For example, the ringback tone server may become overloaded or unavailable to handle a call. As one shortcoming, if the switching center fails to establish a connection to the ringback tone server, the calling party does not receive the ringback tone.

One know approach to handling a failed connection with the ringback tone server is to restore standard ringing to the calling party. For example, the calling party hears the standard ringing sound on calls that fail to connect with the ringback tone server. As one shortcoming, the calling party does not hear the ringback tone. Known ringback tone services are set up as subscription services paid for by the called party. As another shortcoming, if the ringback tone service fails to deliver the ringback tone to the calling party, the called party is likely to be disappointed with the service.

Thus, a need exists for enhanced availability of the ringback tone service after an attempt to route a call to an unavailable ringback tone server.

### SUMMARY

The invention in one implementation encompasses a method. A call is rerouted to an available ringback tone server to play a ringback tone to a calling communication device on the call after an attempt to route the call to an unavailable ringback tone server.

Another implementation of the invention encompasses a method. A call is received from a calling communication device for a called communication device. It is determined that the call meets one or more ringback tone service criteria. The call is sent out on a first trunk path to a first ringback tone server to attempt to play a ringback tone, selected by a user of the called communication device, to the calling communication device. It is determined that the first ringback tone server is unavailable. The call is sent out on a second trunk path to a second ringback tone server to play the ringback tone to the calling communication device.

Yet another implementation of the invention encompasses an apparatus. The apparatus comprises a mobile switching center that routes a call to a first ringback tone server to attempt to play a ringback tone to a calling communication device of the call. The ringback tone is selected by a user of a called communication device of the call. Upon determination that the first ringback tone server is unavailable to handle the call, the mobile switching center routes the call to a second ringback tone server to play the ringback tone to the calling communication device.

### DESCRIPTION OF THE DRAWINGS

Features of exemplary implementations of the invention will become apparent from the description, the claims, and the accompanying drawings in which:

FIG. 1 is a representation of one implementation of an apparatus that comprises one or more mobile switching centers, a plurality of ringback tone servers, one or more data servers, one or more calling communication devices, and one or more called communication devices.

FIG. 2 is a representation of one exemplary message flow for connection of a call to a second ringback tone server after an unsuccessful attempt to connect the call to a first ringback tone server of the plurality of ringback tone servers of the apparatus of FIG. 1.

FIG. 3 is a representation of one exemplary message flow for call setup between a control component and a switch component of the mobile switching center of the apparatus of FIG. 1.

### DETAILED DESCRIPTION

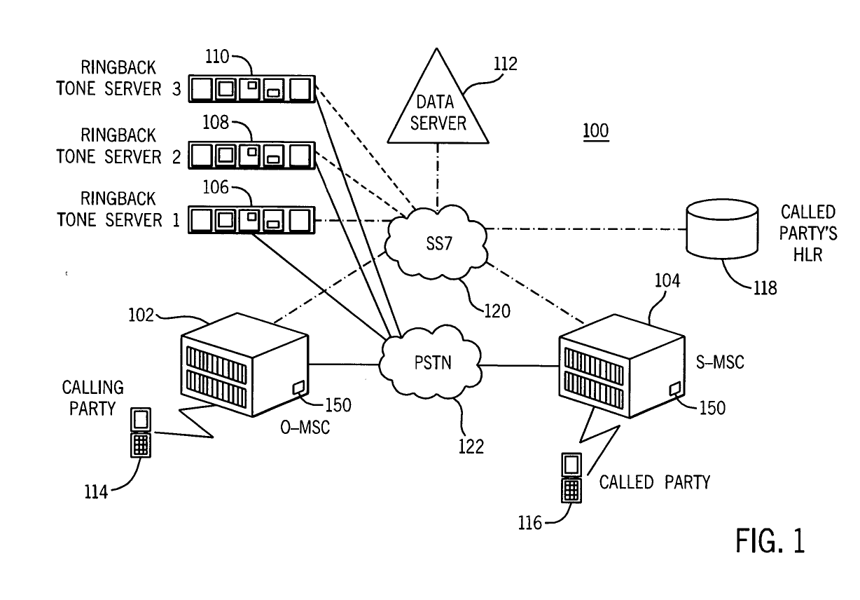

Turning to FIG. 1, an apparatus 100 provides a ringback tone service for wireless and/or wire-line telecommunication systems. The apparatus 100 in one example comprises one or more switching components (e.g., one or more mobile switching centers (“MSCs”) 102 and 104), a plurality of ringback tone servers 106, 108, and 110, one or more data servers 112, one or more calling communication devices 114, and one or more called communication devices 116. The apparatus 100 in one example further comprises a home location register (“HLR”) 118 and/or a visitor location register (“VLR”) associated with the called communication device 116.

A signaling network 120 communicatively couples the MSCs 102 and 104, the ringback tone servers 106, 108, and 110, the data server 112, and the home location register 118. The signaling network 120 in one example comprises a signaling system 7 (“SS7”) network that supports signaling traffic. A bearer network 122 communicatively couples the MSCs 102 and 104, and the ringback tone servers 106, 108, and 110. The bearer network 122 in one example comprises a public switched telephone network (“PSTN”) that supports bearer traffic.

The MSCs 102 and 104 support mobile telecommunication devices, for example, the calling communication device 114 and the called communication device 116. The MSC 102 in one example comprises an originating mobile switching center (“O-MSC”) 102 and the MSC 104 comprises a serving mobile switching center (“S-MSC”) 104. Either the O-MSC 102 or the S-MSC 104 may invoke the ringback tone service. The O-MSC 102 supports a home area of the called communication device 116 and the S-MSC 104 supports a roaming area for the called communication device 116. If the called communication device 116 is within the home area supported by the O-MSC 102, then the S-MSC 104 may not be in the call path between the calling communication device 114 and the called communication device 116. For example, the O-MSC 102 would also serve as a S-MSC for the called communication device 116. The mobile switching centers 102 and 104 comprise an instance of a recordable data storage medium 150, as described herein.

The MSCs 102 and 104 comprise a plurality of Integrated Services Digital Network (“ISDN”) User Part (“ISUP”) trunk routes to ringback tone servers. For example, the O-MSC 102 comprises a first trunk route to the ringback tone server 106, a second trunk route to the ringback tone server 108, and a third trunk route to the ringback tone server 110. The O-MSC 102 maintains a list of available trunk routes that connect with the ringback tone servers 106, 108, and 110. The O-MSC 102 traverses the list to find an available ringback tone server from the group of the ringback tone servers 106, 108, and 110. If a connection attempt through a first trunk route on the list is unsuccessful, then the O-MSC 102 will try a second trunk route on the list to establish a connection with one of the ringback tone servers 106, 108, and 110.

The O-MSC 102 in one example maintains a counter value to indicate the number of times that a connection to one of the ringback tone servers 106, 108, and 110 has been unsuccessful. The O-MSC 102 increments the counter value each time a connection to one of the ringback tone servers 106, 108, and 110 is unsuccessful. The O-MSC 102 compares the counter value to a threshold value. If the counter value is less than the threshold value, then the O-MSC 102 restores a traditional ringing sound to the calling communication device 114. If the counter value exceeds the threshold value, then the O-MSC 102 routes the call to the another one of the ringback tone servers 106, 108, and 110 to play the ringback tone to the calling party 114. The threshold value can be set to any value. In one example, the threshold value may be set to zero to invoke a call reroute for the first ringback tone server connection failure. In another example, the threshold value may be set to a higher value to delay rerouting a call to secondary ringback tone servers.

The ringback tone servers 106, 108, and 110 in one example comprise intelligent peripherals (“IPs”). The ringback tone servers 106, 108, and 110 cooperate with the data server 112 to route calls, connect calls to communication devices, and play ringback tones to calling communication devices. In one example, the ringback tone server 108 cooperates with the data server 112 to play a ringback tone to the calling communication device 114 during a call from the calling communication device 114 for the called communication device 116. The ringback tone servers 106, 108, and 110 and the data server 112 allow a user of the called communication device 116 to preselect the ringback tone played to the calling communication device 114. In one example, the ringback tone server 106 serves as the primary ringback tone server, the ringback tone server 108 serves as the secondary ringback tone server, and the ringback tone server 110 serves as the tertiary ringback tone server. For example, upon receipt of a call that requires a ringback tone, the MSC 102 handling the call will first attempt a connection with the ringback tone server 106. If the connection with the ringback tone server 106 is unsuccessful, then the MSC 102 attempts a connection with the ringback tone server 108. If the connection with the ringback tone server 108 is unsuccessful, then the MSC 102 attempts a connection with the ringback tone server 110. The MSC 102 may also have access to other ringback tone servers in addition to the ringback tone servers 106, 108, and 110.

The data server 112 in one example comprises a service control point (“SCP”). The data server 112 in one example determines that one or more characteristics of the incoming call match one or more ringback tone service criteria set up by the user of the called communication device 116. To initiate the ringback tone service, the data server 106 indicates to the O-MSC 102 to route the incoming call to the ringback tone server 106 to play the preselected ringback tone to the calling communication device 114. The user of the called communication device 116 may instruct the data server 112 to invoke the ringback tone service upon occurrence of an incoming call from a specific calling communication device, an incoming call at a specific time of day, an incoming call on a specific day of the week, an incoming call on any other special day of the year, or other call progress events.

In one example, the ringback tone servers 106, 108 and 110 and the data server 112 comprise separate platforms. In another example, the ringback tone server 106 and the data server 112 comprise portions of a single platform. For example, the functionality of both the ringback tone server 106 and the data server 112 may be combined into one or more intelligent network platforms. If the ringback tone server 106 and the data server 112 are combined into one intelligent network platform, then messages between the ringback tone server 106 and the data server 112 become internal operations of the one intelligent network platform. For example, small applications may employ the one intelligent network platform for the functionality of both the ringback tone server 106 and the data server 112.

The ringback tone service allows the user of the called communication device 116 to preselect a ringback tone to be played to the calling communication device 114 upon occurrence of one or more events. When the calling communication device 114 calls the called communication device 116, a user of the calling communication device 114 normally hears a traditional ringing sound before the called communication device 116 answers the call. However, the ringback tone service replaces the traditional ringing sound with the ringback tone preselected by the user of the called communication device 116. The ringback tone service allow the user of the called communication device 116 to customize the ringing sound that the calling communication device 114 hears upon calling the called communication device 116.

During call setup for the incoming call to the called communication device 116, the O-MSC 102 queries the HLR 118 for service information associated with the called communication device 116. The O-MSC 102 in one example employs the service information to determine that the incoming call for the called communication device will be terminated at one of the ringback tone servers 106, 108, and 110 to play a ringback tone to the calling communication device 114. Therefore, the O-MSC 102 sets a call category for the call to indicate that the call terminates at one of the ringback tone servers 106, 108, and 110. The call category also indicates to the O-MSC 102 to reroute the call to subsequent ringback tone servers if the routing attempt to the first ringback tone server is unsuccessful. The call category in one example comprises a calling party category. The O-MSC 102 sets the calling party category in a call setup message to indicate that the call terminates at one of the ringback tone servers 106, 108 and 110. For example, the O-MSC 102 sets the calling party category to a value that indicates that the call terminates at one of the ringback tone servers 106, 108 and 110 prior to connection with the called communication device 116.

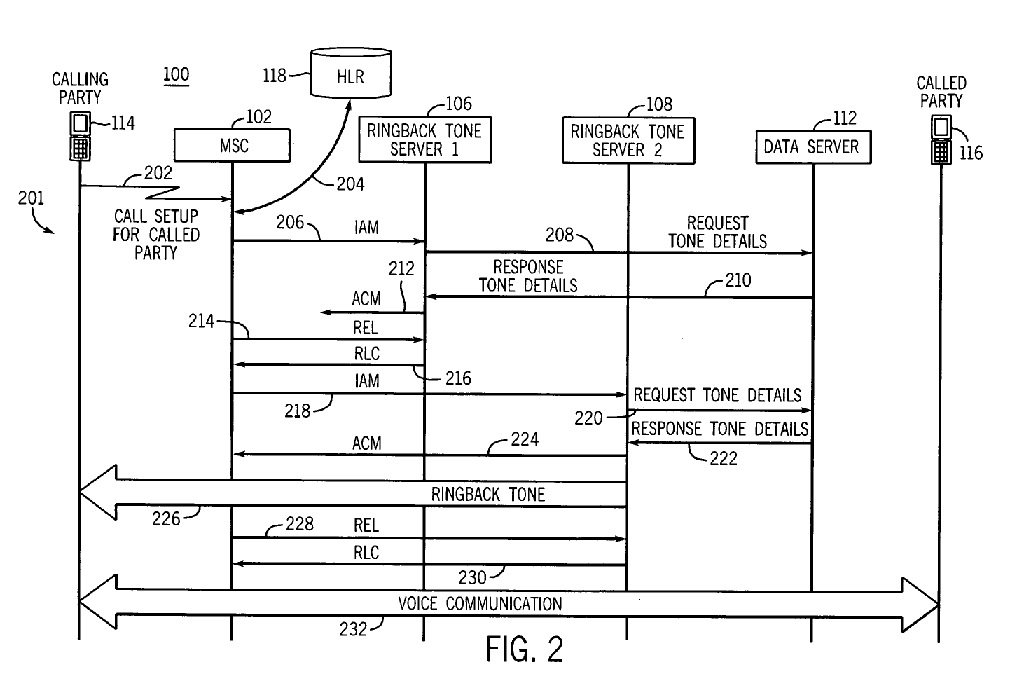

Turning to FIG. 2, an illustrative description of one exemplary operation of the apparatus 100 is now presented, for explanatory purposes. A message flow 201 represents an exemplary connection of a call to the ringback tone server 108 after an unsuccessful attempt to connect the call to the ringback tone server 106. The call is connected with the ringback tone server 108 to play a ringback tone, selected by the called party 116, to the calling party 114. For example, the message flow 201 illustrates a ringback tone service. The called party 116 in one example has configured and activated the ringback tone service prior to the initiation of the message flow 201. For example, the called party 116 has preselected one or more ringback tones for incoming calls that meet one or more criteria.

To initiate a call to the called party 116, the calling party 114 dials the telephone number of the called party 116 resulting in a call setup message 202 being received at the O-MSC 102. The call setup message 202 indicates that the call is for the called party 116. Call processing logic in the O-MSC 102 encounters a Mobile_Termination trigger when processing the call to the called party 116. Upon encountering the Mobile_Termination trigger, the O-MSC 102 initiates a query 204 of the HLR 118. For example, the O-MSC 102 sends a location request invoke (“LOCREQ”) message to the HLR 118 associated with the called party 116. The O-MSC 102 queries the HLR 118 to determine the current location of the called party 116 and whether the call requires a ringback tone played to the calling party 114. The HLR 118 determines a location and service information for the called party 116 and sends a location request return result (“locreq”) message to the O-MSC 102.

In one example, where the calling party 114 comprises a mobile phone, the HLR 118 has been provisioned to return appropriate triggers and address information to the O-MSC 102 based on the characteristics of the call. In another example, where the calling party 114 comprises a landline telephone, the Central Office switch that supports the calling party 114 is provisioned to return triggers and address information to the O-MSC 102 based on the characteristics of the call. If the call requires the ringback tone played to the calling party 114, then the O-MSC 102 terminates the call at one of the ringback tone servers 106, 108, and 110.

Upon determination that the call meets one or more criteria for the ringback tone service, the O-MSC 102 sets a call category to a value that indicates that the call terminates at one of the ringback tone servers 106, 108, and 110. In attempt to extend the call to the ringback tone server 106, the O-MSC 102 sends an initial address message (“IAM”) 206 to the ringback tone server 106. The O-MSC 102 sets a calling party number parameter in the IAM 206 to the directory number (e.g., the telephone number) of the calling party 114. The O-MSC 102 sets a RedirectingNumberDigits parameter in the IAM 206 to the directory number of the called party 116. Also, the O-MSC 102 sets a called party number parameter in the IAM 206 to a routing number employed to extend the call to the ringback tone server 106. For example, the O-MSC 102 sets the called party number parameter to a directory number of the ringback tone server 106 to identify that the call terminates at the ringback tone server 106.

The ringback tone server 106 in one example is overloaded or unavailable to handle the call. After sending the IAM 206 to the ringback tone server 106, the O-MSC 102 waits for a response. For example, if available to handle the call, the ringback tone server 106 will send an address complete message (“ACM”) 212 to the O-MSC 102. However, if the O-MSC 102 does not timely receive the ACM 212, then the O-MSC 102 determines that the ringback tone server 106 is unavailable.

In one example, the ringback tone server 106 is too overloaded to handle the call and takes no action after receiving the IAM 206. In another example, the ringback tone server 106 receives the LAM 206, and continues processing the IAM 206. For example, the ringback tone server 106 sends a tone request message 208 to the data server 112. The ringback tone server 106 queries the data server 112 with information received from the IAM 206. The tone request message 208 requests an indication of the ringback tone that is to be played to the calling party 114 based on one or more characteristics of the call. The tone request message 208 in one example comprises a transfer control protocol/internet protocol (“TCP/IP”) or lightweight directory access protocol (“LDAP”) message. Upon receipt of the tone request message 208, the data server 112 sends a tone response message 210 to the ringback tone server 106. The tone response message 210 indicates which ringback tone to play to the calling party 114.

Upon receipt of the tone response message 210, the ringback tone server 106 sends the ACM 212 to the O-MSC 102. The O-MSC 102 in one example employs a waiting period for the ACM 212 from the ringback tone server 106. The waiting period in one example is set to a value between 0.5 milliseconds and 3 seconds. The ACM 212 in one example does not arrive at the O-MSC 102 at all or arrives at the O-MSC 102 after expiration of the waiting period. If the O-MSC 102 does not receive the ACM 212 within the waiting period, the O-MSC 102 determines that the ringback tone server 106 is unavailable and sends a release (“REL”) message 214 to the ringback tone server 106. In response to the REL message 214, the ringback tone server 106 sends a release complete (“RLC”) message 216 to the O-MSC 102.

After determination that the ringback tone server 106 is unavailable to handle the call, the O-MSC 102 sends an IAM 218 to the ringback tone server 108. The IAM 218 is analogous to the IAM 206, but with the called party number parameter in the IAM 218 set to the directory number of the ringback tone server 108 to identify that the call terminates at the ringback tone server 108. Upon receipt of the IAM 218, the ringback tone server 108 sends a tone request message 220 to the data server 112 and receives a tone response message 222 from the data server 112. The tone response message 222 indicates which ringback tone to play to the calling party 114.

Upon receipt of the tone response message 222, the ringback tone server 108 sends an ACM 224 to the O-MSC 102 to indicate that the ringback tone server 108 is available to handle the ringback tone service call. The ACM 224 is analogous to the ACM 212. After sending the ACM 224, the ringback tone server 108 plays the ringback tone 226 to the calling party 114. For example, the ringback tone server 108 connects the appropriate ringback tone 226 to the calling party 114 on a first leg of the call. The first leg of the call connects the calling party 114 with the ringback tone server 108. After the ringback tone 226 is finished, the O-MSC 102 sends a REL message 228 to the ringback tone server 108. In response to the REL message 228, the ringback tone server 108 sends a RLC message 230 to the O-MSC 102. The REL message 228 and the RLC message 230 are analogous to the REL message 214 and the RLC message 216. To extend the call to the called party 116, the ringback tone server 108 initiates a second leg of the call to the called party 116. The ringback tone server 108 in one example bridges the first call leg with the second call leg to connect the calling party 114 with the called party 116. Upon connection of the first call leg with the second call leg, voice communication 232 ensues.

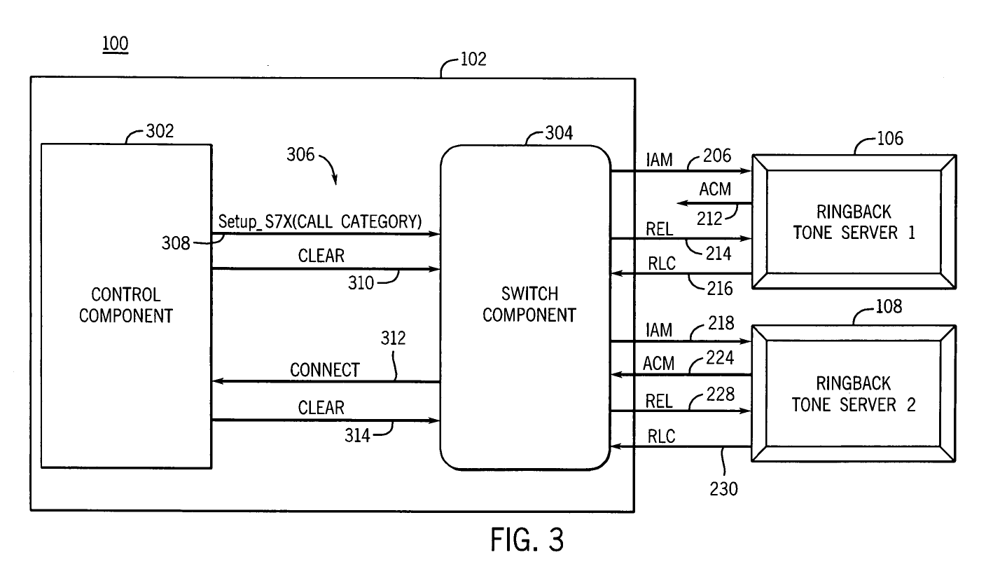

Turning to FIG. 3, the O-MSC 102 in one example comprises a control component 302 and a switch component 304. For example, the control component 302 and the switch component 304 comprise subcomponents of the O-MSC 102. A message flow 306 represents an exemplary call setup between the control component 302 and the switch component 304. For example, the message flow 306 illustrates internal messages of the O-MSC 102 for the call setup.

Upon determination that call meets the criteria to play a ringback tone to the calling party 114, the control component 302 sends a setup message 308 to the switch component 304. “Setup_S7X(call category)” in one example serves to represent the setup message 308. The setup message 308 carries a call category to the switch component 304. The control component 302 may set the call category to indicate one or more characteristics of the call type, calling communication device type, or called communication device type. For example, the call category may indicate that the call terminates at one of the ringback tone servers 106, 108, and 110. The call category may also indicate that the switch component 304 should keep attempting connections with the ringback tone servers 106, 108, and 110 until a connection is successful. The call category in one example comprises a calling party category parameter set in the setup message 308 to indicate that the call should terminate at one of the ringback tone servers 106, 108, and 110. The switch component 304 associates the call category with the call.

In response to the setup message 308, the switch component 304 sends the IAM 206 to the ringback tone server 106. An indication of the ACM 212 in one example does not reach the control component 302 before expiration of a waiting period. Therefore, the control component 302 sends a clear message 310 to the switch component 304. In response to the clear message 310, the switch component 304 sends the REL message 214 to the ringback tone server 108 and then receives the RLC message 216 from the ringback tone server 108.

The connection to the ringback tone server 106 in one example is unsuccessful. Therefore, the switch component 304 sends the IAM 218 to the ringback tone server 108. The ringback tone server 108 sends the ACM 224 to the switch component 304 to indicate availability to handle the call. Upon receipt of the ACM 224, the switch component 304 sends a connect message 312 to the control component 302. The connect message 312 serves to acknowledge the connection with the ringback tone server 108.

After the ringback tone has been played to the calling party 114, the control component 302 sends a clear message 314 to the switch component 304 to initiate call teardown. The clear message 314 serves to initiate a release of trunk resources connected to the ringback tone server 108. The control component 302 releases the ISUP trunk connection to the ringback tone server 108 before the calling party 114 is redirected to the called party 116 to establish voice communication. In response to the clear message 314, the switch component 304 sends the REL message 228 to the ringback tone server 108 and then receives the RLC message 230 from the ringback tone server 108.

The apparatus 100 in one example comprises a plurality of components such as one or more of electronic components, hardware components, and computer software components. A number of such components can be combined or divided in the apparatus 100. An exemplary component of the apparatus 100 employs and/or comprises a set and/or series of computer instructions written in or implemented with any of a number of programming languages, as will be appreciated by those skilled in the art. The apparatus 100 in one example comprises any (e.g., horizontal, oblique, or vertical) orientation, with the description and figures herein illustrating one exemplary orientation of the apparatus 100, for explanatory purposes.

The apparatus 100 in one example employs one or more computer-readable signal-bearing media. The computer-readable signal-bearing media store software, firmware and/or assembly language for performing one or more portions of one or more embodiments of the invention. Examples of a computer-readable signal-bearing medium for the apparatus 100 comprise the recordable data storage medium 150 of the mobile switching centers 102 and 104. The computer-readable signal-bearing medium for the apparatus 100 in one example comprise one or more of a magnetic, electrical, optical, biological, and atomic data storage medium. For example, the computer-readable signal-bearing medium comprise floppy disks, magnetic tapes, CD-ROMs, DVD-ROMs, hard disk drives, and electronic memory. In another example, the computer-readable signal-bearing medium comprises a modulated carrier signal transmitted over a network comprising or coupled with the apparatus 100, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. A method, comprising the step of:
rerouting a call to an available ringback tone server to play a ringback tone to a calling communication device on the call after an attempt to route the call to an unavailable ringback tone server.

2. The method of claim 1, wherein the step of rerouting the call to the available ringback tone server to play the ringback tone to the calling communication device on the call after the attempt to route the call to the unavailable ringback tone server comprises the steps of:
attempting a connection with the unavailable ringback tone server;
determining that the connection to the unavailable ringback tone server was unsuccessful; and
connecting the call to the available ringback tone server to play the ringback tone to the calling communication device.

3. The method of claim 1, wherein the step of rerouting the call to the available ringback tone server to play the ringback tone to the calling communication device on the call after the attempt to route the call to the unavailable ringback tone server comprises the steps of:
traversing a plurality of trunk routes connected with a plurality of ringback tone servers until the available ringback tone server is located; and
employing the available ringback tone server to play the ringback tone to the calling communication device.

4. The method of claim 1, wherein the unavailable ringback tone server comprises a primary ringback tone server, wherein the available ringback tone server comprises a secondary ringback tone server, wherein the step of rerouting the call to the secondary ringback tone server to play the ringback tone to the calling communication device on the call after the attempt to route the call to the primary ringback tone server comprises the steps of:
sending a first initial address message to the primary ringback tone server to attempt to route the call to the primary ringback tone server; and
waiting for the primary ringback tone server to respond with an address complete message that indicates that the primary ringback tone server is available to handle the call.

5. The method of claim 4, further comprising the step of:
sending, upon expiration of a waiting period for the address complete message from the primary ringback tone server, a second initial address message to the secondary ringback tone server to attempt to route the call to the secondary ringback tone server.

6. The method of claim 5, wherein the call comprises a first call, the method further comprising the steps of:
receiving a second call after the first call; and
sending a third initial address message to the primary ringback tone server to determine whether the primary ringback tone server has become available to handle the second call.

7. The method of claim 1, wherein the unavailable ringback tone server comprises a primary ringback tone server, wherein the available ringback tone server comprises a secondary ringback tone server, the method further comprising the steps of:
determining whether a connection to the secondary ringback tone server was successful;
employing the secondary ringback tone server to play the ringback tone to the calling communication device if the connection to the secondary ringback tone server was successful; and
attempting to connect to a tertiary ringback tone server if the connection to the secondary ringback tone server was unsuccessful.

8. The method of claim 1, further comprising the step of:
setting a call category for the call to indicate that the call comprises a ringback tone service call that involves a connection to one of a plurality of ringback tone servers.

9. The method of claim 1, wherein the unavailable ringback tone server comprises a primary ringback tone server, wherein the available ringback tone server comprises a secondary ringback tone server, the method further comprising the steps of:
incrementing a counter value each time a connection to the primary ringback tone server is unsuccessful;
comparing the counter value to a threshold value; and
routing the call to the secondary ringback tone server if the counter value exceeds the threshold value.

10. The method of claim 9, further comprising the step of:
restoring a traditional ringing sound to the calling communication device if the counter value is less than the threshold value.

11. A method, comprising the steps of:
receiving a call from a calling communication device for a called communication device;
determining that the call meets one or more ringback tone service criteria;
sending the call out on a first trunk path to a first ringback tone server to attempt to play a ringback tone, selected by a user of the called communication device, to the calling communication device;
determining that the first ringback tone server is unavailable; and
sending the call out on a second trunk path to a second ringback tone server to play the ringback tone to the calling communication device.

12. The method of claim 11, wherein the step of sending the call out on the first trunk path to the first ringback tone server to attempt to play the ringback tone, selected by the user of the called communication device, to the calling communication device comprises the steps of:
sending a first initial address message to the first ringback tone server to attempt to route the call to the first ringback tone server; and
waiting for the first ringback tone server to respond with an address complete message that indicates that the first ringback tone server is available to handle the call;
wherein the step of sending the call out on the second trunk path to the second ringback tone server to play the ringback tone to the calling communication device comprises the step of:
sending, upon expiration of a waiting period for the address complete message from the first ringback tone server, a second initial address message to the second ringback tone server to attempt to route the call to the second ringback tone server.

13. The method of claim 11, wherein the step of sending the call out on the second trunk path to the second ringback tone server to play the ringback tone to the calling communication device comprises the steps of:
traversing a plurality of trunk paths connected with a plurality of ringback tone servers until an available ringback tone server is located; and
employing the available ringback tone server to play the ringback tone to the calling communication device.

14. An apparatus, comprising:
a mobile switching center that routes a call to a first ringback tone server to attempt to play a ringback tone to a calling communication device of the call, wherein the ringback tone is selected by a user of a called communication device of the call;
wherein upon determination that the first ringback tone server is unavailable to handle the call, the mobile switching center routes the call to a second ringback tone server to play the ringback tone to the calling communication device.

15. The apparatus of claim 14, wherein the mobile switching center sends a first initial address message to the first ringback tone server to attempt to route the call to the first ringback tone server;
wherein the mobile switching center waits for the first ringback tone server to respond with an address complete message that indicates that the first ringback tone server is available to handle the call.

16. The apparatus of claim 15, wherein upon expiration of a waiting period for the address complete message from the first ringback tone server, the mobile switching center sends a second initial address message to the second ringback tone server to attempt to route the call to the second ringback tone server.

17. The apparatus of claim 16, wherein the call comprises a first call, wherein the mobile switching center receives a second call after the first call;
wherein the mobile switching center sends a third initial address message to the first ringback tone server to determine whether the first ringback tone server has become available to handle the second call.

18. The apparatus of claim 14, wherein the second ringback tone server comprises an available ringback tone server, wherein the mobile switching center traverses a plurality of trunk routes connected with a plurality of ringback tone servers until the available ringback tone server is located;
wherein the mobile switching center employs the available ringback tone server to play the ringback tone to the calling communication device.

19. The apparatus of claim 14, wherein the mobile switching center sets a call category for the call to indicate that the call comprises a ringback tone service call that involves a connection to one of a plurality of ringback tone servers.

20. The apparatus of claim 14, wherein the mobile switching center increments a counter value each time a connection to the first ringback tone server is unsuccessful, wherein the mobile switching center compares the counter value to a threshold value;
wherein the mobile switching center routes the call to the second ringback tone server if the counter value exceeds the threshold value, wherein the mobile switching center restore a traditional ringing sound to the calling communication device if the counter value is less than the threshold value.
